(19) United States
(12) Patent Application Publication
(10) Pub. No.: US 2013/0268586 A1
(43) Pub. Date: Oct. 10, 2013

(54) COMMUNICATION METHOD BETWEEN IP TERMINAL AND CLIENT

(71) Applicant: Jung-Bok Lee, Chungbuk (KR)

(72) Inventor: Jung-Bok Lee, Chungbuk (KR)

(73) Assignee: GETRON CO., LTD., Cheongju-si, Chungbuk (KR)

(21) Appl. No.: 13/991,540

(22) PCT Filed: Nov. 16, 2011
(86) PCT No.: PCT/KR11/08741

§ 371 Date: Jun. 4, 2013

(30) Foreign Application Priority Data
Dec. 29, 2010 (KR) 10-2010-0137913

(51) Int. Cl. H04L 29/06

(52) U.S. Cl. CPC H04L 67/42
USPC 709/203

(57) ABSTRACT

A communication method between an IP terminal and a client is provided to simplify a task for installing an IP terminal in an IP network by improving a communication method between the client and the IP terminal, a communication method between an IP terminal and a client over an IP network without the port mapping or port forwarding of an IP sharer, and a communication method between an IP terminal and a client, which enables even an ordinary person without specialized knowledge to install the IP terminal because the port mapping or port forwarding of an IP sharer is not performed.

### BACKGROUND OF THE INVENTION

1. Technical Field

The present invention relates to a communication method between an IP terminal and a client.

2. Description of the Related Art

Recently, with the improvement of network speed and the development of an IP terminal, many products are coming into wide use which can access the Internet anywhere, communicate voice, video, and data through an IP terminal everywhere in the world where the IP terminal is installed, and control other devices at a desired place through the IP terminal. However, there are some prerequisites to be solved in order to easily install and conveniently utilize the products.

In a conventional technique in which an IP terminal is installed at a desired place and used, when installing the IP terminal, understanding of an installation environment is necessary. Although an installation environment has been understood, there are financial burdens of hiring an installation expert because complicate setting for a network device is necessary. Furthermore, even an installation expert finds difficult to install an IP terminal, and an initial installation time and an initial installation cost are high even though a cheap IP terminal is manufactured and sold.

### SUMMARY OF THE INVENTION

Accordingly, the present invention has been made keeping in mind the above problems occurring in the prior art, and an object of the present invention is to provide a communication method between an IP terminal and a client, which can simplify a task for installing an IP terminal in an IP network by improving a communication method between the client and the IP terminal.

Another object of the present invention is to provide a communication method between an IP terminal and a client over an IP network without the port mapping or port forwarding of an IP sharer.

Yet another object of the present invention is to provide a communication method between an IP terminal and a client, which enables even an ordinary person without specialized knowledge to install the IP terminal because the port mapping or port forwarding of an IP sharer is not performed.

Further yet another object of the present invention is to provide a communication method between an IP terminal and a client, which can reduce the time and costs necessary to install the IP terminal because the port mapping or port forwarding of an IP sharer is not performed is not performed.

In an aspect of the present invention, there is provided a communication method between an IP terminal and a client in a system including a server configured to have a static certified IP address and port number, the IP terminal configured to have a private IP address and have its own unique information already registered with the server, the client that is another IP terminal having a private IP address and trying to communicate with the IP terminal through the server, IP terminal-side sharing devices configured to connect the IP terminal to an Internet over a network and to include at least one of an IP sharer and a router each having a private IP address on a LAN side and having a certified IP address on a WAN side, and client-side sharing devices configured to connect the client to the Internet over the network and to include at least one of an IP sharer and a router each having a private IP address on the LAN side and having a certified IP address on the WAN side, wherein communication between the server and the IP terminal, the client and the IP terminal-side sharing devices, and the client-side sharing devices is performed according to an IP method. The communication method includes the steps of the server regularly managing the unique information of the IP terminal and the WAN-side certified IP address and port number of the IP terminal-side sharing device corresponding to information related to the IP terminal, which are periodically transmitted by the IP terminal; when communication request data including the unique information of the IP terminal is received from the client, the server sending the information related to the IP terminal to the WAN-side certified IP address and port number of the client-side sharing device so that the client receives the information related to the IP terminal and sending the WAN-side certified IP address and port number of the client-side sharing device, corresponding to information related to the client, to the WAN-side certified IP address and port number of the IP terminal-side sharing device so that the IP terminal receives the information related to the client; and the client sending data to be transmitted to the IP terminal to the WAN-side certified IP address and port number of the IP terminal-side sharing device, and the IP terminal sending data to be transmitted to the client to the WAN-side certified IP address and port number of the client-side sharing device, so the IP terminal and the client communicate with each other.

In another aspect of the present invention, there is provided a communication method between an IP terminal and a client in a system including a server configured to have a static certified IP address and port number, the IP terminal configured to have a private IP address and have its own unique information already registered with the server, the client that is another IP terminal having a private IP address and trying to communicate with the IP terminal through the server, and IP terminal-side sharing devices configured to connect the IP terminal to an Internet over a network and to include at least one of an IP sharer and a router each having a private IP address on a LAN side and having a certified IP address on a WAN side, wherein communication between the server and the IP terminal and between the client and the IP terminal-side sharing device is performed according to an IP method. The communication method includes the steps of the server regularly managing the unique information of the IP terminal and the WAN-side certified IP address and port number of the IP terminal-side sharing device corresponding to information related to the IP terminal, which are periodically transmitted by the IP terminal; when communication request data including the unique information of the IP terminal is received from the client, the server sending the information related to the IP terminal to the certified IP address and port number of the client and sending the certified IP address and port number of the client, corresponding to information related to the client, to the WAN-side certified IP address and port number of the IP terminal-side sharing device so that the IP terminal receives the information related to the client; and the client sending data to be transmitted to the IP terminal to the WAN-side certified IP address and port number of the IP terminal-side sharing device, and the IP terminal sending data to be transmitted to the client to the certified IP address and port number of the client, so the IP terminal and the client communicate with each other.

In yet another aspect of the present invention, there is provided a communication method between an IP terminal and a client in a system including a server configured to have a static certified IP address and port number, the IP terminal configured to have a private IP address and have its own unique information already registered with the server, the client that is another IP terminal having a private IP address and trying to communicate with the IP terminal through the server, and client-side sharing devices configured to connect the client to the Internet over the network and to include at least one of an IP sharer and a router each having a private IP address on the LAN side and having a certified IP address on the WAN side, wherein communication between the server and the IP terminal and between the client and the client-side sharing devices is performed according to an IP method. The communication method includes the steps of the server regularly managing the unique information of the IP terminal and the certified IP address and port number of the IP terminal corresponding to information related to the IP terminal, which are periodically transmitted by the IP terminal; when communication request data including the unique information of the IP terminal is received from the client, the server sending the information related to the IP terminal to the WAN-side certified IP address and port number of the client-side sharing device so that the client receives the information related to the IP terminal and sending the WAN-side certified IP address and port number of the client-side sharing device, corresponding to information related to the client, to the WAN-side certified IP address and port number of the IP terminal-side sharing device; and the client sending data to be transmitted to the IP terminal to the certified IP address and port number of the IP terminal, and the IP terminal sending data to be transmitted to the client to the WAN-side certified IP address and port number of the client-side sharing device, so the IP terminal and the client communicate with each other.

In further yet another aspect of the present invention, there is provided a communication method between an IP terminal and a client in a system including a server configured to have a static certified IP address and port number, the IP terminal configured to have a private IP address and have its own unique information already registered with the server, the client that is another IP terminal having a private IP address and trying to communicate with the IP terminal through the server, IP terminal-side sharing devices configured to connect the IP terminal to an Internet over a network and to include at least one of an IP sharer and a router each having a private IP address on a LAN side and having a certified IP address on a WAN side, and client-side sharing devices configured to connect the client to the Internet over the network and to include at least one of an IP sharer and a router each having a private IP address on the LAN side and having a certified IP address on the WAN side, wherein communication between the server and the IP terminal, the client and the IP terminal-side sharing devices, and the client-side sharing devices is performed according to an IP method. The communication method includes the steps of the server regularly managing the unique information of the IP terminal and the WAN-side certified IP address and port number of the IP terminal-side sharing device corresponding to information related to the IP terminal, which are periodically transmitted by the IP terminal; when communication request data including the unique information of the IP terminal is received from the client, the server sending the information related to the IP terminal to the WAN-side certified IP address and port number of the client-side sharing device so that the client receives the information related to the IP terminal; and the client sending data to be transmitted to the IP terminal to the WAN-side certified IP address and port number of the IP terminal-side sharing device, and the IP terminal sending data to be transmitted to the client to the WAN-side certified IP address and port number of the client-side sharing device that have been obtained by analyzing the data received from the client, so the IP terminal and the client communicate with each other.

In further yet another aspect of the present invention, there is provided a communication method between an IP terminal and a client in a system including a server configured to have a static certified IP address and port number, the IP terminal configured to have a certified IP address and have its own unique information already registered with the server, and the client that is another IP terminal having a certified IP address and trying to communicate with the IP terminal through the server, wherein communication between the server, the IP terminal, and the client is performed according to an IP method. The communication method includes the steps of the server regularly managing the unique information of the IP terminal and the certified IP address and port number of the IP terminal corresponding to information related to the IP terminal, which are periodically transmitted by the IP terminal; when communication request data including the unique information of the IP terminal is received from the client, the server sending the information related to the IP terminal to the certified IP address and port number of the client; and the client sending data to be transmitted to the IP terminal to the certified IP address and port number of the IP terminal, and the IP terminal sending data to be transmitted to the client to the certified IP address and port number of the client that have been obtained by analyzing the data received from the client so that the IP terminal and the client communicate with each other.

In further yet another aspect of the present invention, there is provided a communication method between an IP terminal and a client in a system including a server configured to have a static certified IP address and port number, the IP terminal configured to have a private IP address and have its own unique information already registered with the server, the client that is another IP terminal having a private IP address and trying to communicate with the IP terminal through the server, and IP terminal-side sharing devices configured to connect the IP terminal to an Internet over a network and to include at least one of an IP sharer and a router each having a private IP address on a LAN side and having a certified IP address on a WAN side, wherein communication between the server and the IP terminal and between the client and the IP terminal-side sharing device is performed according to an IP method. The communication method includes the steps of the server regularly managing the unique information of the IP terminal and the WAN-side certified IP address and port number of the IP terminal-side sharing device corresponding to information related to the IP terminal, which are periodically transmitted by the IP terminal; when communication request data including the unique information of the IP terminal is received from the client, the server sending the information related to the IP terminal to the certified IP address and port number of the client; and the client sending data to be transmitted to the IP terminal to the WAN-side certified IP address and port number of the IP terminal-side sharing device, and the IP terminal sending data to be transmitted to the client to the certified IP address and port number of the client that have been obtained by analyzing the data received from the client so that the IP terminal and the client communicate with each other.

In further yet another aspect of the present invention, there is provided a communication method between an IP terminal and a client in a system including a server configured to have a static certified IP address and port number, the IP terminal configured to have a private IP address and have its own unique information already registered with the server, the client that is another IP terminal having a private IP address and trying to communicate with the IP terminal through the server, and client-side sharing devices configured to connect the client to the Internet over the network and to include at least one of an IP sharer and a router each having a private IP address on the LAN side and having a certified IP address on the WAN side, wherein communication between the server and the IP terminal and between the client and the client-side sharing devices is performed according to an IP method. The communication method includes the steps of the server regularly managing the unique information of the IP terminal and the certified IP address and port number of the IP terminal corresponding to information related to the IP terminal, which are periodically transmitted by the IP terminal; when communication request data including the unique information of the IP terminal is received from the client, the server sending the information related to the IP terminal to the WAN-side certified IP address and port number of the client-side sharing device so that the client receives the information related to the IP terminal; and the client sending data to be transmitted to the IP terminal to the certified IP address and port number of the IP terminal and the IP terminal sending data to be transmitted to the client to the WAN-side certified IP address and port number of the client-side sharing device that have been obtained by analyzing the data received from the client, so the IP terminal and the client communicate with each other.

In further yet another aspect of the present invention, there is provided a communication method between an IP terminal and a client in a system including a server configured to have a static certified IP address and port number, the IP terminal configured to have a private IP address and have its own unique information already registered with the server, the client that is another IP terminal having a private IP address and trying to communicate with the IP terminal through the server, IP terminal-side sharing devices configured to connect the IP terminal to an Internet over a network and to include at least one of an IP sharer and a router each having a private IP address on a LAN side and having a certified IP address on a WAN side, and client-side sharing devices configured to connect the client to the Internet over the network and to include at least one of an IP sharer and a router each having a private IP address on the LAN side and having a certified IP address on the WAN side, wherein communication between the server and the IP terminal, the client and the IP terminal-side sharing devices, and the client-side sharing devices is performed according to an IP method. The communication method includes the steps of the server regularly managing the unique information of the IP terminal and the WAN-side certified IP address and port number of the IP terminal-side sharing device corresponding to information related to the IP terminal, which are periodically transmitted by the IP terminal; when communication request data including the unique information of the IP terminal is received from the client, the server sending the WAN-side certified IP address and port number of the client-side sharing device, corresponding to information related to the client, to the WAN-side certified IP address and port number of the IP terminal-side sharing device so that the IP terminal receives the information related to the client; and the IP terminal sending data to be transmitted to the client to the WAN-side certified IP address and port number of the client-side sharing device and the client sending data to be transmitted to the IP terminal to the WAN-side certified IP address and port number of the IP terminal-side sharing device that have been obtained by analyzing the data received from the IP terminal, so the IP terminal and the client communicate with each other.

In further yet another aspect of the present invention, there is provided a communication method between an IP terminal and a client in a system including a server configured to have a static certified IP address and port number, the IP terminal configured to have a private IP address and have its own unique information already registered with the server, the client that is another IP terminal having a private IP address and trying to communicate with the IP terminal through the server, and IP terminal-side sharing devices configured to connect the IP terminal to an Internet over a network and to include at least one of an IP sharer and a router each having a private IP address on a LAN side and having a certified IP address on a WAN side, wherein communication between the server and the IP terminal and between the client and the IP terminal-side sharing device is performed according to an IP method. The communication method includes the steps of the server regularly managing the unique information of the IP terminal and the WAN-side certified IP address and port number of the IP terminal-side sharing device corresponding to information related to the IP terminal, which are periodically transmitted by the IP terminal; when communication request data including the unique information of the IP terminal is received from the client, the server sending the certified IP address and port number of the client, corresponding to information related to the client, to the WAN-side certified IP address and port number of the IP terminal-side sharing device so that the IP terminal receives the information related to the client; and the IP terminal sending data to be transmitted to the client to the certified IP address and port number of the client and the client sending data to be transmitted to the IP terminal to the WAN-side certified IP address and port number of the IP terminal-side sharing device that have been obtained by analyzing the data received from the IP terminal, so the IP terminal and the client communicate with each other.

In further yet another aspect of the present invention, there is provided a communication method between an IP terminal and a client in a system including a server configured to have a static certified IP address and port number, the IP terminal configured to have a private IP address and have its own unique information already registered with the server, the client that is another IP terminal having a private IP address and trying to communicate with the IP terminal through the server, and client-side sharing devices configured to connect the client to the Internet over the network and to include at least one of an IP sharer and a router each having a private IP address on the LAN side and having a certified IP address on the WAN side, wherein communication between the server and the IP terminal and between the client and the client-side sharing devices is performed according to an IP method. The communication method includes the steps of the server regularly managing the unique information of the IP terminal and the certified IP address and port number of the IP terminal corresponding to information related to the IP terminal, which are periodically transmitted by the IP terminal; when communication request data including the unique information of the IP terminal is received from the client, the server sending the WAN-side certified IP address and port number of the client-side sharing device, corresponding to information related to the client, to the certified IP address and port number of the IP terminal; and the IP terminal sending data to be transmitted to the client to the WAN-side certified IP address and port number of the client-side sharing device and the client sending data to be transmitted to the IP terminal to the certified IP address and port number of the IP terminal that have been received by analyzing the data received from the IP terminal, so the IP terminal and the client communicate with each other.

In further yet another aspect of the present invention, one client communicates with a plurality of the IP terminals simultaneously or a plurality of the clients communicates with one terminal simultaneously.

### BRIEF DESCRIPTION OF THE DRAWINGS

FIGS. 1, 3, and 4 show system configurations in accordance with embodiments of the present invention; and

FIG. 2 shows IP terminal-related information recorded and managed by a server in accordance with an embodiment of the present invention.

### DETAILED DESCRIPTION OF THE INVENTION

Some exemplary embodiments of the present invention are described in detail with reference to the accompanying drawings.

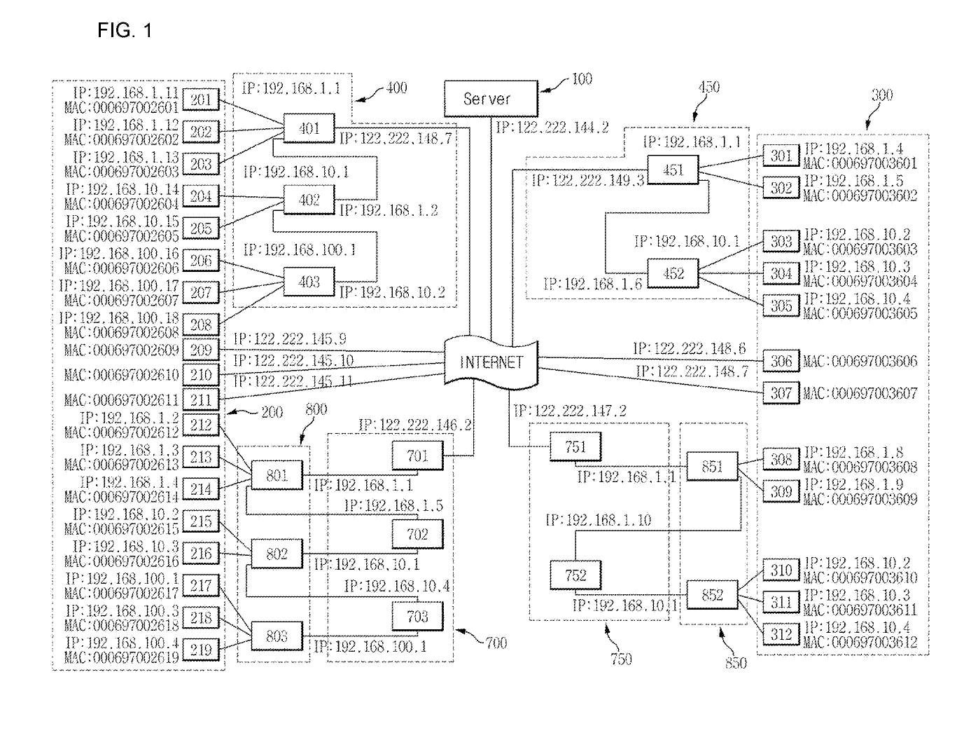

FIGS. 1, 3, and 4 show system configurations in accordance with embodiments of the present invention.

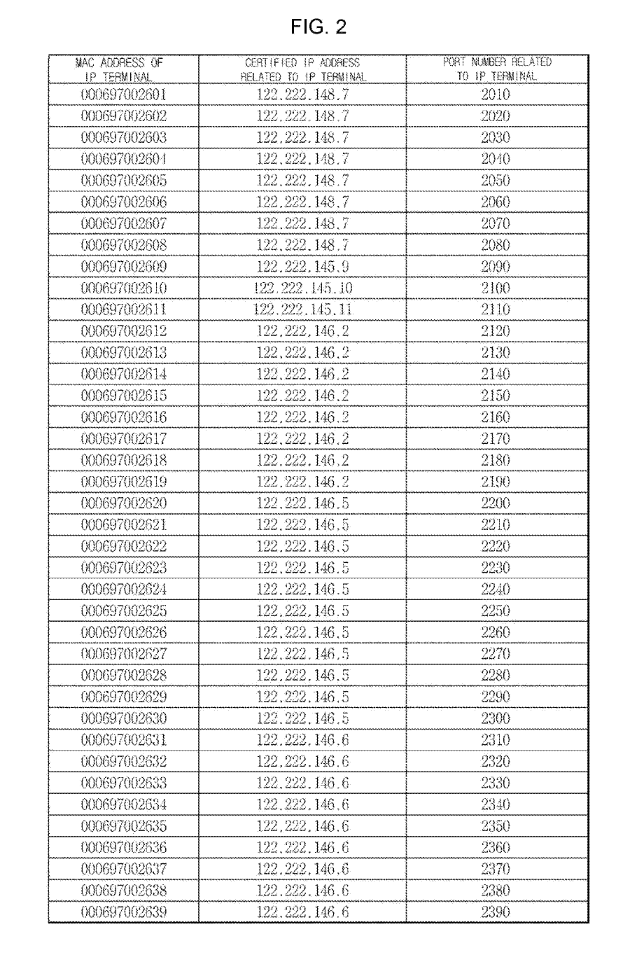

FIG. 2 shows IP terminal-related information recorded and managed by a server in accordance with an embodiment of the present invention.

Referring to FIG. 1, 3, 4, each of the system configurations in accordance with the embodiments of the present invention includes a server 100, an IP terminal 200, a client 300, IP sharers 400 and 450, routers 700 and 750, switching hubs 800 and 850, etc.

The server 100 has a static certified IP address and port number.

The IP terminal 200 has a private IP address or a certified IP address and has its own unique information already registered with the server 100.

The client 300 is another IP terminal. The client 300 has a private IP address or a certified IP address and can perform communication with the IP terminal 200 using the server 100.

The IP terminal-side sharing devices 400 and 700 function to connect the IP terminal 200 to the Internet over a network and includes at least one of the IP sharer 400 and the router 700 which has a private IP address on the LAN side and a certified IP address on the WAN side.

The client-side sharing devices 450 and 750 function to connect the client 300 to the Internet over a network and includes at least one of the IP sharer 450 and the router 750 which has a private IP address on the LAN side and a certified IP address on the WAN side.

In a communication method between the IP terminal 200 and the client 300 in accordance with an embodiment of the present invention, communication between the server 100 and the IP terminal 200, the client 300 and the IP terminal-side sharing devices 400 and 700, and the client-side sharing devices 450 and 750 is performed according to an IP method.

In a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the WAN-side certified IP address and port number of the IP terminal-side sharing devices 400 and 700 corresponding to information related to the IP terminal, which are periodically transmitted by the IP terminal 200.

Thereafter, when the server 100 receives communication request data, including the unique information about the IP terminal 200, from the client 300, the server 100 sends the information related to the IP terminal to the WAN-side certified IP address and port number of the client-side sharing devices 450 and 750 so that the client 300 receives the information related to the IP terminal and also sends the WAN-side certified IP address and port number of the client-side sharing devices 450 and 750, corresponding to information related to the client, to the WAN-side certified IP address and port number of the IP terminal-side sharing devices 400 and 700 so that the IP terminal 200 receives the information related to the client.

Finally, the client 300 sends data to be transmitted to the IP terminal 200 to the WAN-side certified IP address and port number of the IP terminal-side sharing devices 400 and 700, and the IP terminal 200 also sends data to be transmitted to data to be transmitted to the client 300 to the WAN-side certified IP address and port number of the client-side sharing devices 450 and 750, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the certified IP address and port number of the IP terminal 200 corresponding to information related to the IP terminal, which are periodically transmitted by the IP terminal 200.

Thereafter, when the server 100 receives communication request data, including the unique information about the IP terminal 200, from the client 300, the server 100 sends the information related to the IP terminal to the certified IP address and port number of the client 300 and also sends the certified IP address and port number of the client 300, corresponding to information related to the client, to the certified IP address and port number of the IP terminal 200.

Finally, the client 300 sends data to be transmitted to the IP terminal 200 to the certified IP address and port number of the IP terminal 200, and the IP terminal 200 also sends data to be transmitted to the client 300 to the certified IP address and port number of the client 300, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the WAN-side certified IP address and port number of the IP terminal-side sharing devices 400 and 700 corresponding to information related to the IP terminal, which are periodically transmitted by the IP terminal 200.

Thereafter, when the server 100 receives communication request data, including the unique information about the IP terminal 200, from the client 300, the server 100 sends the information related to the IP terminal to the certified IP address and port number of the client 300 and also sends the certified IP address and port number of the client 300, corresponding to information related to the client, to the WAN-side certified IP address and port number of the IP terminal-side sharing devices 400 and 700 so that the IP terminal 200 receives the information related to the client.

Finally, the client 300 sends data to be transmitted to the IP terminal 200 to the WAN-side certified IP address and port number of the IP terminal-side sharing devices 400 and 700, and the IP terminal 200 also sends data to be transmitted to the client 300 to the certified IP address and port number of the client 300, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the certified IP address and port number of the IP terminal 200 corresponding to information related to the IP terminal, which are periodically transmitted by the IP terminal 200.

Thereafter, when the server 100 receives communication request data, including the unique information about the IP terminal 200, from the client 300, the server 100 sends the information related to the IP terminal to the WAN-side certified IP address and port number of the client-side sharing devices 450 and 750 so that the client 300 receives the information related to the IP terminal and also sends the WAN-side certified IP address and port number of the client-side sharing devices 450 and 750, corresponding to information related to the client, to the certified IP address and port number of the IP terminal 200.

Finally, the client 300 sends data to be transmitted to the IP terminal 200 to the certified IP address and port number of the IP terminal 200, and the IP terminal 200 also sends data to be transmitted to the client 300 to the WAN-side certified IP address and port number of the client-side sharing devices 450 and 750, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the WAN-side certified IP address and port number of the IP terminal-side sharing devices 400 and 700 corresponding to information related to the IP terminal, which are periodically transmitted by the IP terminal 200.

Thereafter, when the server 100 receives communication request data, including the unique information about the IP terminal 200, from the client 300, the server 100 sends the information related to the IP terminal to the WAN-side certified IP address and port number of the client-side sharing devices 450 and 750 so that the client 300 receives the information related to the IP terminal.

Finally, the client 300 sends data to be transmitted to the IP terminal 200 to the WAN-side certified IP address and port number of the IP terminal-side sharing devices 400 and 700, and the IP terminal 200 also sends data to be transmitted to the client 300 to the WAN-side certified IP address and port number of the client-side sharing devices 450 and 750 that have been obtained by analyzing the data received from the client 300, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the certified IP address and port number of the IP terminal 200 corresponding to information related to the IP terminal, which are periodically transmitted by the IP terminal 200.

Thereafter, when the server 100 receives communication request data, including the unique information about the IP terminal 200, from the client 300, the server 100 sends the information related to the IP terminal to the certified IP address and port number of the client 300.

Finally, the client 300 sends data to be transmitted to the IP terminal 200 to the certified IP address and port number of the IP terminal 200, and the IP terminal 200 also sends data to be transmitted to the client 300 to the certified IP address and port number of the client 300 that have been obtained by analyzing the data received from the client 300, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the WAN-side certified IP address and port number of the IP terminal-side sharing devices 400 and 700 corresponding to information related to the IP terminal, which are periodically transmitted by the IP terminal 200.

Thereafter, when the server 100 receives communication request data, including the unique information about the IP terminal 200, from the client 300, the server 100 sends the information related to the IP terminal to the certified IP address and port number of the client 300.

Finally, the client 300 sends data to be transmitted to the IP terminal 200 to the WAN-side certified IP address and port number of the IP terminal-side sharing devices 400 and 700, and the IP terminal 200 also sends data to be transmitted to the client 300 to the certified IP address and port number of the client 300 that have been obtained by analyzing the data received from the client 300, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the certified IP address and port number of the IP terminal 200 corresponding to information related to the IP terminal, which are periodically transmitted by the IP terminal 200.

Thereafter, when the server 100 receives communication request data, including the unique information about the IP terminal 200, from the client 300, the server 100 sends the information related to the IP terminal to the WAN-side certified IP address and port number of the client-side sharing devices 450 and 750 so that the client 300 receives the information related to the IP terminal.

Finally, the client 300 sends data to be transmitted to the IP terminal 200 to the certified IP address and port number of the IP terminal 200, and the IP terminal 200 also sends data to be transmitted to the client 300 to the WAN-side certified IP address and port number of the client-side sharing devices 450 and 750 that have been obtained by analyzing the data received from the client 300, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the WAN-side certified IP address and port number of the IP terminal-side sharing devices 400 and 700 corresponding to information related to the IP terminal, which are periodically transmitted by the IP terminal 200.

Thereafter, when the server 100 receives communication request data, including the unique information about the IP terminal 200, from the client 300, the server 100 sends the WAN-side certified IP address and port number of the client-side sharing devices 450 and 750, corresponding to information related to the client, to the WAN-side certified IP address and port number of the IP terminal-side sharing devices 400 and 700 so that the IP terminal 200 can receive information related to the client.

Finally, the IP terminal 200 sends data to be transmitted to the client 300 to the WAN-side certified IP address and port number of the client-side sharing devices 450 and 750, and the client 300 also sends data to be transmitted to the IP terminal 200 to the WAN-side certified IP address and port number of the IP terminal-side sharing devices 400 and 700 that have been obtained by analyzing the data received from the IP terminal 200, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the certified IP address and port number of the IP terminal 200 corresponding to information related to the IP terminal, which are periodically transmitted by the IP terminal 200.

Thereafter, when the server 100 receives communication request data, including the unique information about the IP terminal 200, from the client 300, the server 100 sends the certified IP address and port number of the client 300, corresponding to information related to the client, to the certified IP address and port number of the IP terminal 200.

Finally, the IP terminal 200 sends data to be transmitted to the client 300 to the certified IP address and port number of the client 300, and the client 300 also sends data to be transmitted to the IP terminal 200 to the certified IP address and port number of the IP terminal 200 that have been obtained by analyzing the data received from the IP terminal 200, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the WAN-side certified IP address and port number of the IP terminal-side sharing devices 400 and 700 corresponding to information related to the IP terminal, which are periodically transmitted by the IP terminal 200.

Thereafter, when the server 100 receives communication request data, including the unique information about the IP terminal 200, from the client 300, the server 100 sends the certified IP address and port number of the client 300, corresponding to information related to the client, to the WAN-side certified IP address and port number of the IP terminal-side sharing devices 400 and 700 so that the IP terminal 200 receives the information related to the client.

Finally, the IP terminal 200 sends data to be transmitted to the client 300 to the certified IP address and port number of the client 300, and the client 300 also sends data to be transmitted to the IP terminal 200 to the WAN-side certified IP address and port number of the IP terminal-side sharing devices 400 and 700 that have been obtained by analyzing the data received from the IP terminal 200, so the IP terminal 200 and the client 300 communicate with each other.

Furthermore, in a communication method between the IP terminal 200 and the client 300 in accordance with an embodiment of the present invention, the IP terminal 200 and the client 300 sequentially perform communication according to the following steps.

The server 100 regularly manages unique information about the IP terminal 200 and the certified IP address and port number of the IP terminal 200 corresponding to information related to the IP terminal, which are periodically transmitted by the IP terminal 200.

Thereafter, when the server 100 receives communication request data, including the unique information about the IP terminal 200, from the client 300, the server 100 sends the WAN-side certified IP address and port number of the client-side sharing devices 450 and 750, corresponding to information related to the client, to the certified IP address and port number of the IP terminal 200.

Finally, the IP terminal 200 sends data to be transmitted to the client 300 to the WAN-side certified IP address and port number of the client-side sharing devices 450 and 750, and the client 300 also sends data to be transmitted to the IP terminal 200 to the certified IP address and port number of the IP terminal 200 that have been obtained by analyzing the data received from the IP terminal 200, so the IP terminal 200 and the client 300 communicate with each other.

The communication methods between the IP terminal 200 and the client 300 in accordance with the embodiments of the present invention are described in more detail below.

It is assumed that a static certified IP address has been assigned to the server 100 as shown in FIGS. 1, 3, and 4.

It is also assumed that certified IP addresses have been assigned to IP terminals 209, 210, and 211, clients 306 and 307, IP sharers 401, 407, 451, and 456 on the WAN side, and routers 701, 704, 751, and 753 on the WAN side.

It is also assumed that private IPs have been assigned to IP terminals 201 to 208 and 212 to 239, clients 301 to 305 and 308 to 331, the IP sharers 401, 407, 451, and 456 on the LAN side, IP sharers 402 to 406, 408, 409, 452 to 455, 457, and 458 on the WAN and LAN sides, the routers 701, 704, 751, and 753 on the LAN side, and routers 702, 703, 705, 706, 752, 754, and 755 on the WAN and LAN sides.

Here, the certified IP address can be an automatically assigned IP address or an IP address directly assigned by an installer.

The IP terminal 200 having its own unique information already registered with the server 100 sends the unique information (e.g., MAC address) to the server 100 whenever a specific time (e.g., 10 seconds) elapses.

The server 100 stores information related to the IP terminals 201 to 208 and 212 to 239, including the respective private IP addresses and having respective pieces of unique information (e.g., MAC addresses) already registered with the server 100, whenever the server 100 receives the pieces of unique information about the IP terminals 201 to 208 and 212 to 239 from the IP terminals 201 to 208 and 212 to 239.

Here, the information related to the IP terminals 201 to 208 and 212 to 239 can include the MAC addresses of the IP terminals 201 to 208 and 212 to 239 and the certified IP addresses and port numbers of the first IP sharers 401, 407, 451, and 456 or the routers 701, 704, 751, and 753 having respective certified IP addresses as WAN-side IP addresses, from among the IP sharers 400 and 450 and the routers 700 and 750 through which the unique information (e.g., MAC addresses) of the IP terminals 201 to 208 and 212 to 239 is transmitted from the IP terminals 201 to 208 and 212 to 239 to the server 100.

The server 100 stores information related to the IP terminals 209, 210, and 211, including respective pieces of unique information (e.g., MAC addresses) and having their certified IP addresses already registered with the server 100, whenever the server 100 receives the unique information of the IP terminals 209, 210, and 211 from the IP terminals 209, 210, and 211.

Here, the information related to the IP terminals 209, 210, and 211 can include the MAC addresses, IP addresses, and port numbers of the IP terminals 209, 210, and 211.

FIG. 2 shows an example of information recorded and managed by the server 100. Hereinafter, an example in which one of the clients 300 communicates with a specific IP terminal based on the information is described in detail.

For example, as shown in FIG. 1, the client 301 sends communication request data, including the unique information (e.g., MAC address) of the IP terminal 201 with which the client 301 will communicate, to the certified IP address ‘122.222.144.2’ and port number ‘9500’ of the server 100.

In response thereto, the server 100 first sends information that is necessary for the client 301 to send data to the IP terminal 201 to the WAN-side certified IP address ‘122.222.148.7’ and port number ‘2010’ of the IP sharer 401 so that the IP terminal 201 can received the information.

That is, the server 100 sends the WAN-side certified IP address ‘122.222.148.7’ and port number ‘2010’ of the IP sharer 401 to the WAN-side certified IP address ‘112.222.149.3’ and port number ‘3010’ of the IP sharer 451 so that the client 301 receives the WAN-side certified IP address ‘122.222.148.7’ and port number ‘2010’.

Thereafter, the server 100 sends the WAN-side certified IP address ‘112.222.149.3’ and port number ‘3010’ of the IP sharer 451, corresponding to information necessary for the IP terminal 201 to send data to the client 301, to the WAN-side certified IP address ‘122.222.148.7’ and port number ‘2010’ of the IP sharer 401 so that the IP terminal 201 receives the WAN-side certified IP address ‘112.222.149.3’ and port number ‘3010’.

Next, the client 301 sends the data to be transmitted to the IP terminal 201 to the WAN-side certified IP address ‘122.222.148.7’ and port number ‘2010’ of the IP sharer 401 that have been received from the server 100, and the IP terminal 201 sends the data to be transmitted to the client 301 to the WAN-side certified IP address ‘112.222.149.3’ and port number ‘3010’ of the IP sharer 451 that have been received from the server 100, so the IP terminal 201 and the client 301 communicate with each other.

Here, the data is transmitted according to an IP method.

For another example, as shown in FIG. 1, the client 305 sends communication request data, including the unique information (e.g., MAC address) of the IP terminal 208 with which the client 305 will communicate, to the certified IP address ‘122.222.144.2’ and port number ‘9500’ of the server 100.

In response thereto, the server 100 first sends information that is necessary for the client 305 to send data to the IP terminal 208 to the WAN-side certified IP address ‘122.222.148.7’ and port number ‘2080’ of the IP sharer 401 so that the IP terminal 208 receives the information.

That is, the server 100 sends the WAN-side certified IP address ‘122.222.148.7’ and port number ‘2080’ of the IP sharer 401 to the WAN-side certified IP address ‘112.222.149.3’ and port number ‘3050’ of the IP sharer 451 so that the client 305 receives the WAN-side certified IP address ‘122.222.148.7’ and port number ‘2080’.

Thereafter, the server 100 sends the WAN-side certified IP address ‘112.222.149.3’ and port number ‘3050’ of the IP sharer 451, corresponding to information necessary for the IP terminal 208 to send the data to the client 305, to the WAN-side certified IP address ‘122.222.148.7’ and port number ‘2080’ of the IP sharer 401 so that the IP terminal 208 receives the WAN-side certified IP address ‘112.222.149.3’ and port number ‘3050’.

Next, the client 305 sends the data to be transmitted to the IP terminal 208 to the WAN-side certified IP address ‘122.222.148.7’ and port number ‘2080’ of the IP sharer 401 that have been received from the server 100, and the IP terminal 208 sends the data to be transmitted to the client 305 to the WAN-side certified IP address ‘112.222.149.3’ and port number ‘3050’ of the IP sharer 451 that have been received from the server 100, so the IP terminal 208 and the client 305 communicate with each other.

Here, the data is transmitted according to an IP method.

For another example, as shown in FIG. 1, the client 308 sends communication request data, including the unique information (e.g., MAC address) of the IP terminal 212 with which the client 308 will communicate, to the certified IP address ‘122.222.144.2’ and port number ‘9500’ of the server 100.

In response thereto, the server 100 first sends information that is necessary for the client 308 to send data to the IP terminal 212 to the WAN-side certified IP address ‘112.222.146.2’ and port number ‘2120’ of the router 701 so that the IP terminal 212 receives the information.

That is, the server 100 sends the WAN-side certified IP address ‘112.222.146.2’ and port number ‘2120’ of the router 701 to the WAN-side certified IP address ‘112.222.147.2’ and port number ‘3080’ of the router 751 so that the client 308 receives the WAN-side certified IP address ‘112.222.146.2’ and port number ‘2120’.

Thereafter, the server 100 sends the WAN-side certified IP address ‘112.222.147.2’ and port number ‘3080’ of the router 751, corresponding to information necessary for the IP terminal 212 to send data to the client 308, to the WAN-side certified IP address ‘112.222.146.2’ and port number ‘2120’ of the router 701 so that the IP terminal 212 receives the WAN-side certified IP address ‘112.222.147.2’ and port number ‘3080’.

Next, the client 308 sends the data to be transmitted to the IP terminal 212 to the WAN-side certified IP address ‘112.222.146.2’ and port number ‘2120’ of the router 701 that have been received from the server 100, and the IP terminal 212 sends the data to be transmitted to the client 308 to the WAN-side certified IP address ‘112.222.147.2’ and port number ‘3080’ of the router 751 that have been received from the server 100, so the IP terminal 212 and the client 308 communicate with each other.

Here, the data is transmitted according to an IP method.

For another example, as shown in FIG. 1, the client 312 sends communication request data, including the unique information (e.g., MAC address) of the IP terminal 219 with which the client 312 will communicate, to the certified IP address ‘122.222.144.2’ and port number ‘9500’ of the server 100.

In response thereto, the server 100 first sends information that is necessary for the client 312 to send data to the IP terminal 219 to the WAN-side certified IP address ‘112.222.146.2’ and port number ‘2190’ of the router 701 so that the IP terminal 219 can receives the information.

That is, the server 100 sends the WAN-side certified IP address ‘112.222.146.2’ and port number ‘2190’ of the router 701 to the WAN-side certified IP address ‘112.222.147.2’ and port number ‘3120’ of the router 751 so that the client 312 receives the WAN-side certified IP address ‘112.222.146.2’ and port number ‘2190’.

Thereafter, the server 100 sends the WAN-side certified IP address ‘112.222.147.2’ and port number ‘3120’ of the router 751, corresponding to information necessary for the IP terminal 219 to send data to the client 312, to the WAN-side certified IP address ‘112.222.146.2’ and port number ‘2190’ of the router 701 so that the IP terminal 219 receives the WAN-side certified IP address ‘112.222.147.2’ and port number ‘3120’.

Next, the client 312 sends the data to be transmitted to the IP terminal 219 to the WAN-side certified IP address ‘112.222.146.2’ and port number ‘2190’ of the router 701 that have been received from the server 100, and the IP terminal 219 sends the data to be transmitted to the client 312 to the WAN-side certified IP address ‘112.222.147.2’ and port number ‘3120’ of the router 751 that have been received from the server 100, so the IP terminal 219 and the client 312 communicate with each other.

Here, the data is transmitted according to an IP method.

For another example, as shown in FIG. 1, the client 310 sends communication request data, including the unique information (e.g., MAC address) of the IP terminal 209 with which the client 310 will communicate, to the certified IP address ‘122.222.144.2’ and port number ‘9500’ of the server 100.

In response thereto, the server 100 first sends information that is necessary for the client 310 to send data to the IP terminal 209 to the certified IP address ‘122.222.145.9’ and port number ‘2090’ of the IP terminal 209 so that the IP terminal 209 receives the information.

That is, the server 100 sends the certified IP address ‘122.222.145.9’ and port number ‘2090’ of the IP terminal 209 to the WAN-side certified IP address ‘112.222.147.2’ and port number ‘3100’ of the router 751 so that the client 310 receives the certified IP address ‘122.222.145.9’ and port number ‘2090’.

Thereafter, the server 100 sends the WAN-side certified IP address ‘112.222.147.2’ and port number ‘3100’ of the router 751, corresponding to information necessary for the IP terminal 209 to send data to the client 310, to the certified IP address ‘122.222.145.9’ and port number ‘2090’ of the IP terminal 209 so that the IP terminal 209 receives the WAN-side certified IP address ‘112.222.147.2’ and port number ‘3100’.

Next, the client 310 sends the data to be transmitted to the IP terminal 209 to the certified IP address ‘122.222.145.9’ and port number ‘2090’ of the IP terminal 209 that have been received from the server 100, and the IP terminal 209 sends the data to be transmitted to the client 310 to the WAN-side certified IP address ‘112.222.147.2’ and port number ‘3100’ of the router 751 that have been received from the server 100, so the IP terminal 209 and the client 310 communicate with each other.

Here, the data is transmitted according to an IP method.

For another example, as shown in FIG. 1, the client 306 sends communication request data, including the unique information (e.g., MAC address) of the IP terminal 209 with which the client 306 will communicate, to the certified IP address ‘122.222.144.2’ and port number ‘9500’ of the server 100.

In response thereto, the server 100 first sends information that is necessary for the client 306 to send data to the IP terminal 209 to the certified IP address ‘122.222.145.9’ and port number ‘2090’ of the IP terminal 209 so that the IP terminal 209 receives the information.

That is, the server 100 sends the certified IP address ‘122.222.145.9’ and port number ‘2090’ of the IP terminal 209 to the certified IP address ‘122.222.148.6’ and port number ‘3060’ of the client 306 so that the client 306 receives the certified IP address ‘122.222.145.9’ and port number ‘2090’.

Thereafter, the server 100 sends the certified IP address ‘122.222.148.6’ and port number ‘3060’ of the client 306, corresponding to information necessary for the IP terminal 209 to send data to the client 306, to the certified IP address ‘122.222.145.9’ and port number ‘2090’ of the IP terminal 209 so that the IP terminal 209 receives the certified IP address ‘122.222.148.6’ and port number ‘3060’.

Next, the client 306 sends the data to be transmitted to the IP terminal 209 to the certified IP address ‘122.222.145.9’ and port number ‘2090’ of the IP terminal 209 that have been from the server 100, and the IP terminal 209 sends the data to be transmitted to the client 306 to the certified IP address ‘122.222.148.6’ and port number ‘3060’ of the client 306 that have been received from the server 100, so the IP terminal 209 and the client 306 communicate with each other.

Here, the data is transmitted according to an IP method.

For another example, as shown in FIG. 1, the client 307 sends communication request data, including the unique information (e.g., MAC address) of the IP terminal 206 with which the client 307 will communicate, to the certified IP address ‘122.222.144.2’ and port number ‘9500’ of the server 100.

In response thereto, the server 100 first sends information that is necessary for the client 307 to send data to the IP terminal 206 to the WAN-side certified IP address ‘122.222.148.7’ and port number ‘2060’ of the IP sharer 401 so that the IP terminal 206 receives the information.

That is, the server 100 sends the WAN-side certified IP address ‘122.222.148.7’ and port number ‘2060’ of the IP sharer 401 to the certified IP address ‘122.222.148.7’ and port number ‘3070’ of the client 307 so that the client 307 receives the WAN-side certified IP address ‘122.222.148.7’ and port number ‘2060’.

Thereafter, the server 100 sends the certified IP address ‘122.222.148.7’ and port number ‘3070’ of the client 307, corresponding to information necessary for the IP terminal 206 to send data to the client 307, to the WAN-side certified IP address ‘122.222.148.7’ and port number ‘2060’ of the IP sharer 401 so that the IP terminal 206 receives the certified IP address ‘122.222.148.7’ and port number ‘3070’.

Next, the client 307 sends the data to be transmitted to the IP terminal 206 to the WAN-side certified IP address ‘122.222.148.7’ and port number ‘2060’ of the IP sharer 401 that have been received from the server 100, and the IP terminal 206 sends the data to be transmitted to the client 307 to the certified IP address ‘122.222.148.7’ and port number ‘3070’ of the client 307 that have been received from the server 100, so the IP terminal 206 and the client 307 communicate with each other.

Here, the data is transmitted according to an IP method.

For another example, as shown in FIG. 1, the client 307 sends communication request data, including the unique information (e.g., MAC address) of the IP terminal 217 with which the client 307 will communicate, to the certified IP address ‘122.222.144.2’ and port number ‘9500’ of the server 100.

In response thereto, the server 100 first sends information that is necessary for the client 307 to send data to the IP terminal 217 to the WAN-side certified IP address ‘112.222.146.2’ and port number ‘2170’ of the router 701 so that the IP terminal 217 receives the information.

That is, the server 100 sends the WAN-side certified IP address ‘112.222.146.2’ and port number ‘2170’ of the router 701 to the certified IP address ‘122.222.148.7’ and port number ‘3070’ of the client 307 so that the client 307 receives the WAN-side certified IP address ‘112.222.146.2’ and port number ‘2170’.

Thereafter, the server 100 sends the certified IP address ‘122.222.148.7’ and port number ‘3070’ of the client 307, corresponding to information necessary for the IP terminal 217 to send data to the client 307, to the WAN-side certified IP address ‘112.222.146.2’ and port number ‘2170’ of the router 701 so that the IP terminal 217 receives the certified IP address ‘122.222.148.7’ and port number ‘3070’.

Next, the client 307 sends the data to be transmitted to the IP terminal 217 to the WAN-side certified IP address ‘112.222.146.2’ and port number ‘2170’ of the router 701 that have been received from the server 100, and the IP terminal 217 sends the data to be transmitted to the client 307 to the certified IP address ‘122.222.148.7’ and port number ‘3070’ of the client 307 that have been received from the server 100, so the IP terminal 217 and the client 307 communicate with each other.

Here, the data is transmitted according to an IP method.

For another example, as shown in FIG. 1, the client 304 sends communication request data, including the unique information (e.g., MAC address) of the IP terminal 211 with which the client 304 will communicate, to the certified IP address ‘122.222.144.2’ and port number ‘9500’ of the server 100.

In response thereto, the server 100 first sends information that is necessary for the client 304 to send data to the IP terminal 211 to the certified IP address ‘122.222.145.11’ and port number ‘2110’ of the IP terminal 211 so that the IP terminal 211 receives the information.

That is, the server 100 sends the certified IP address ‘122.222.145.11’ and port number ‘2110’ of the IP terminal 211 to the WAN-side certified IP address ‘112.222.149.3’ and port number ‘3040’ of the IP sharer 451 so that the client 304 receives the certified IP address ‘122.222.145.11’ and port number ‘2110’.

Thereafter, the server 100 sends the WAN-side certified IP address ‘112.222.149.3’ and port number ‘3040’ of the IP sharer 451, corresponding to information necessary for the IP terminal 211 to send data to the client 304, to the certified IP address ‘122.222.145.11’ and port number ‘2110’ of the IP terminal 211 so that the IP terminal 211 receives the WAN-side certified IP address ‘112.222.149.3’ and port number ‘3040’.

Next, the client 304 sends the data to be transmitted to the IP terminal 211 to the certified IP address ‘122.222.145.11’ and port number ‘2110’ of the IP terminal 211 that have been received from the server 100, and the IP terminal 211 sends the data to be transmitted to the client 304 to the WAN-side certified IP address ‘112.222.149.3’ and port number ‘3040’ of the IP sharer 451 that have been received from the server 100, so the IP terminal 211 and the client 304 communicate with each other.

Here, the data is transmitted according to an IP method.

For another example, as shown in FIG. 1, the client 311 sends communication request data, including the unique information (e.g., MAC address) of the IP terminal 207 with which the client 311 will communicate, to the certified IP address ‘122.222.144.2’ and port number ‘9500’ of the server 100.

In response thereto, the server 100 first sends information that is necessary for the client 311 to send data to the IP terminal 207 to the WAN-side certified IP address ‘122.222.148.7’ and port number ‘2070’ of the IP sharer 401 so that the IP terminal 207 receives the information.

That is, the server 100 sends the WAN-side certified IP address ‘122.222.148.7’ and port number ‘2070’ of the IP sharer 401 to the WAN-side certified IP address ‘112.222.147.2’ and port number ‘3110’ of the router 751 so that the client 311 receives the WAN-side certified IP address ‘122.222.148.7’ and port number ‘2070’.

Thereafter, the server 100 sends the WAN-side certified IP address ‘112.222.147.2’ and port number ‘3110’ of the router 751, corresponding to information necessary for the IP terminal 207 to send data to the client 311, to the WAN-side certified IP address ‘122.222.148.7’ and port number ‘2070’ of the IP sharer 401 so that the IP terminal 207 receives the WAN-side certified IP address ‘112.222.147.2’ and port number ‘3110’.

Next, the client 311 sends the data to be transmitted to the IP terminal 207 to the WAN-side certified IP address ‘122.222.148.7’ and port number ‘2070’ of the IP sharer 401 that have been received from the server 100, and the IP terminal 207 sends the data to be transmitted to the client 311 to the WAN-side certified IP address ‘112.222.147.2’ and port number ‘3110’ of the router 751 that have been received from the server 100, so the IP terminal 207 and the client 311 communicate with each other.

Here, the data is transmitted according to an IP method.

For another example, as shown in FIG. 1, the client 304 sends communication request data, including the unique information (e.g., MAC address) of the IP terminal 218 with which the client 304 will communicate, to the certified IP address ‘122.222.144.2’ and port number ‘9500’ of the server 100.

In response thereto, the server 100 first sends information that is necessary for the client 304 to send data to the IP terminal 218 to the WAN-side certified IP address ‘112.222.146.2’ and port number ‘2180’ of the router 701 so that the IP terminal 218 receives the information.

That is, the server 100 sends the WAN-side certified IP address ‘112.222.146.2’ and port number ‘2180’ of the router 701 to the WAN-side certified IP address ‘112.222.149.3’ and port number ‘3040’ of the IP sharer 451 so that the client 304 receives the WAN-side certified IP address ‘112.222.146.2’ and port number ‘2180’.

Thereafter, the server 100 sends the WAN-side certified IP address ‘112.222.149.3’ and port number ‘3040’ of the IP sharer 451, corresponding to information necessary for the IP terminal 218 to send data to the client 304, to the WAN-side certified IP address ‘112.222.146.2’ and port number ‘2180’ of the router 701 so that the IP terminal 218 receives the WAN-side certified IP address ‘112.222.149.3’ and port number ‘3040’.

Next, the client 304 sends the data to be transmitted to the IP terminal 218 to the WAN-side certified IP address ‘112.222.146.2’ and port number ‘2180’ of the router 701 that have been received from the server 100, and the IP terminal 218 sends the data to be transmitted to the client 304 to the WAN-side certified IP address ‘112.222.149.3’ and port number ‘3040’ of the IP sharer 451 that have been received from the server 100, so the IP terminal 218 and the client 304 communicate with each other.

Here, the data is transmitted according to an IP method.

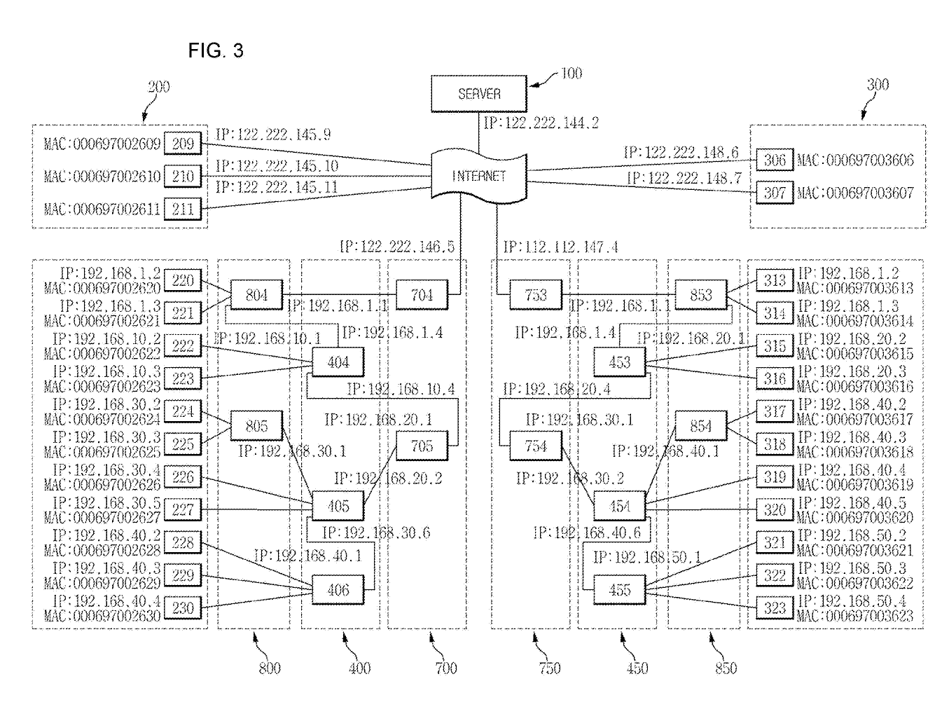

For an example, as shown in FIG. 3, the client 321 sends communication request data, including the unique information (e.g., MAC address) of the IP terminal 209 with which the client 321 will communicate, to the certified IP address ‘122.222.144.2’ and port number ‘9500’ of the server 100.

In response thereto, the server 100 first sends information that is necessary for the client 321 to send data to the IP terminal 209 to the certified IP address ‘122.222.145.9’ and port number ‘2090’ of the IP terminal 209 so that the IP terminal 209 receives the information.

That is, the server 100 sends the certified IP address ‘122.222.145.9’ and port number ‘2090’ of the IP terminal 209 to the WAN-side certified IP address ‘112.112.147.4’ and port number ‘3210’ of the router 753 so that the client 321 receives the certified IP address ‘122.222.145.9’ and port number ‘2090’.

Thereafter, the server 100 sends the WAN-side certified IP address ‘112.112.147.4’ and port number ‘3210’ of the router 753, corresponding to information necessary for the IP terminal 209 to send data to the client 321, to the certified IP address ‘122.222.145.9’ and port number ‘2090’ of the IP terminal 209 so that the IP terminal 209 receives the WAN-side certified IP address ‘112.112.147.4’ and port number ‘3210’.

Next, the client 321 sends the data to be transmitted to the IP terminal 209 to the certified IP address ‘122.222.145.9’ and port number ‘2090’ of the IP terminal 209 that have been received from the server 100, and the IP terminal 209 sends the data to be transmitted to the client 321 to the WAN-side certified IP address ‘112.112.147.4’ and port number ‘3210’ of the router 753 that have been received from the server 100, so the IP terminal 209 and the client 321 communicate with each other.

Here, the data is transmitted according to an IP method.

For another example, as shown in FIG. 3, the client 307 sends communication request data, including the unique information (e.g., MAC address) of the IP terminal 230 with which the client 307 will communicate, to the certified IP address ‘122.222.144.2’ and port number ‘9500’ of the server 100.

In response thereto, the server 100 first sends information that is necessary for the client 307 to send data to the IP terminal 230 to the WAN-side certified IP address ‘112.222.146.5’ and port number ‘2300’ of the router 704 so that the IP terminal 230 receives the information.

That is, the server 100 sends the WAN-side certified IP address ‘112.222.146.5’ and port number ‘2300’ of the router 704 to the certified IP address ‘122.222.148.7’ and port number ‘3070’ of the client 307 so that the client 307 receives the WAN-side certified IP address ‘112.222.146.5’ and port number ‘2300’.

Thereafter, the server 100 sends the certified IP address ‘122.222.148.7’ and port number ‘3070’ of the client 307, corresponding to information necessary for the IP terminal 230 to send data to the client 307, to the WAN-side certified IP address ‘112.222.146.5’ and port number ‘2300’ of the router 704 so that the IP terminal 230 receives the certified IP address ‘122.222.148.7’ and port number ‘3070’.

Next, the client 307 sends the data to be transmitted to the IP terminal 230 to the WAN-side certified IP address ‘112.222.146.5’ and port number ‘2300’ of the router 704 that have been received from the server 100, and the IP terminal 230 sends the data to be transmitted to the client 307 to the certified IP address ‘122.222.148.7’ and port number ‘3070’ of the client 307 that have been received from the server 100, so the IP terminal 230 and the client 307 communicate with each other.

Here, the data is transmitted according to an IP method.

For another example, as shown in FIG. 3, the client 322 sends communication request data, including the unique information (e.g., MAC address) of the IP terminal 228 with which the client 322 will communicate, to the certified IP address ‘122.222.144.2’ and port number ‘9500’ of the server 100.

In response thereto, the server 100 first sends information that is necessary for the client 322 to send data to the IP terminal 228 to the WAN-side certified IP address ‘112.222.146.5’ and port number ‘2280’ of the router 704 so that the IP terminal 228 receives the information.

That is, the server 100 sends the WAN-side certified IP address ‘112.222.146.5’ and port number ‘2280’ of the router 704 to the WAN-side certified IP address ‘112.112.147.4’ and port number ‘3220’ of the router 753 so that the client 322 receives the WAN-side certified IP address ‘112.222.146.5’ and port number ‘2280’.

Thereafter, the server 100 sends the WAN-side certified IP address ‘112.112.147.4’ and port number ‘3220’ of the router 753, corresponding to information necessary for the IP terminal 228 to send data to the client 322, to the WAN-side certified IP address ‘112.222.146.5’ and port number ‘2280’ of the router 704 so that the IP terminal 228 receives the WAN-side certified IP address ‘112.112.147.4’ and port number ‘3220’.

Next, the client 322 sends the data to be transmitted to the IP terminal 228 to the WAN-side certified IP address ‘112.222.146.5’ and port number ‘2280’ of the router 704 that have been received from the server 100, and the IP terminal 228 sends the data to be transmitted to the client 322 to the WAN-side certified IP address ‘112.112.147.4’ and port number ‘3220’ of the router 753 that have been received from the server 100, so the IP terminal 228 and the client 322 communicate with each other.

Here, the data is transmitted according to an IP method.

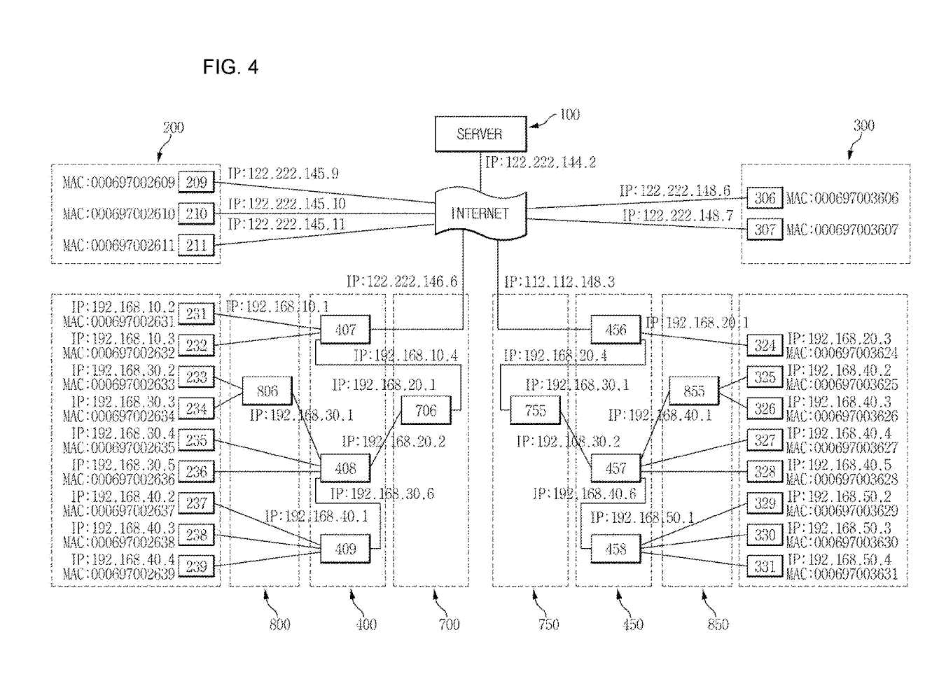

For an example, as shown in FIG. 4, the client 331 sends communication request data, including the unique information (e.g., MAC address) of the IP terminal 209 with which the client 331 will communicate, to the certified IP address ‘122.222.144.2’ and port number ‘9500’ of the server 100.

In response thereto, the server 100 first sends information that is necessary for the client 331 to send data to the IP terminal 209 to the certified IP address ‘122.222.145.9’ and port number ‘2090’ of the IP terminal 209 so that the IP terminal 209 receives the information.

That is, the server 100 sends the certified IP address ‘122.222.145.9’ and port number ‘2090’ of the IP terminal 209 to the WAN-side certified IP address ‘112.226.148.3’ and port number ‘3310’ of the IP sharer 456 so that the client 331 receives the certified IP address ‘122.222.145.9’ and port number ‘2090’.

Thereafter, the server 100 sends the WAN-side certified IP address ‘112.226.148.3’ and port number ‘3310’ of the IP sharer 456, corresponding to information necessary for the IP terminal 209 to send data to the client 331, to the certified IP address ‘122.222.145.9’ and port number ‘2090’ of the IP terminal 209 so that the IP terminal 209 receives the WAN-side certified IP address ‘112.226.148.3’ and port number ‘3310’.

Next, the client 331 sends the data to be transmitted to the IP terminal 209 to the certified IP address ‘122.222.145.9’ and port number ‘2090’ of the IP terminal 209 that have been received from the server 100, and the IP terminal 209 sends the data to be transmitted to the client 331 to the WAN-side certified IP address ‘112.226.148.3’ and port number ‘3310’ of the IP sharer 456 that have been received from the server 100, so the IP terminal 209 and the client 331 communicate with each other.

Here, the data is transmitted according to an IP method.

For another example, as shown in FIG. 4, the client 307 sends communication request data, including the unique information (e.g., MAC address) of the IP terminal 239 with which the client 307 will communicate, to the certified IP address ‘122.222.144.2’ and port number ‘9500’ of the server 100.

In response thereto, the server 100 first sends information that is necessary for the client 307 to send data to the IP terminal 239 to the WAN-side certified IP address ‘112.225.146.6’ and port number ‘2390’ of the IP sharer 407 so that the IP terminal 239 receives the information.

That is, the server 100 sends the WAN-side certified IP address ‘112.225.146.6’ and port number ‘2390’ of the IP sharer 407 to the certified IP address ‘122.222.148.7’ and port number ‘3070’ of the client 307 so that the client 307 receives the WAN-side certified IP address ‘112.225.146.6’ and port number ‘2390’.

Thereafter, the server 100 sends the certified IP address ‘122.222.148.7’ and port number ‘3070’ of the client 307, corresponding to information necessary for the IP terminal 239 to send data to the client 307, to the WAN-side certified IP address ‘112.225.146.6’ and port number ‘2390’ of the IP sharer 407 so that the IP terminal 239 receives the certified IP address ‘122.222.148.7’ and port number ‘3070’.

Next, the client 307 sends the data to be transmitted to the IP terminal 239 to the WAN-side certified IP address ‘112.225.146.6’ and port number ‘2390’ of the IP sharer 407 that have been received from the server 100, and the IP terminal 239 sends the data to be transmitted to the client 307 to the certified IP address ‘122.222.148.7’ and port number ‘3070’ of the client 307 that have been received from the server 100, so the IP terminal 239 and the client 307 communicate with each other.

Here, the data is transmitted according to an IP method.

For another example, as shown in FIG. 4, the client 330 sends communication request data, including the unique information (e.g., MAC address) of the IP terminal 238 with which the client 330 will communicate, to the certified IP address ‘122.222.144.2’ and port number ‘9500’ of the server 100.

In response thereto, the server 100 first sends information that is necessary for the client 330 to send data to the IP terminal 238 to the WAN-side certified IP address ‘112.225.146.6’ and port number ‘2380’ of the IP sharer 407 so that the IP terminal 238 receives the information.

That is, the server 100 sends the WAN-side certified IP address ‘112.225.146.6’ and port number ‘2380’ of the IP sharer 407 to the WAN-side certified IP address ‘112.226.148.3’ and port number ‘3300’ of the IP sharer 456 so that the client 330 receives the WAN-side certified IP address ‘112.225.146.6’ and port number ‘2380’.

Thereafter, the server 100 sends the WAN-side certified IP address ‘112.226.148.3’ and port number ‘3300’ of the IP sharer 456, corresponding to information necessary for the IP terminal 238 to send data to the client 330, to the WAN-side certified IP address ‘112.225.146.6’ and port number ‘2380’ of the IP sharer 407 so that the IP terminal 238 receives the WAN-side certified IP address ‘112.226.148.3’ and port number ‘3300’.

Next, the client 330 sends the data to be transmitted to the IP terminal 238 to the WAN-side certified IP address ‘112.225.146.6’ and port number ‘2380’ of the IP sharer 407 that have been received from the server 100, and the IP terminal 238 sends the data to be transmitted to the client 330 to the WAN-side certified IP address ‘112.226.148.3’ and port number ‘3300’ of the IP sharer 456 that have been received from the server 100, so the IP terminal 238 and the client 330 communicate with each other.

Here, the data is transmitted according to an IP method.

Meanwhile, in accordance with an embodiment of the present invention, one client 300 may communicate with a plurality of the IP terminals 200 at the same time, or a plurality of the clients 300 may communicate with one terminal 200 at the same time.

The embodiment of the present invention includes the server 100, the IP terminal 200, the client 300, the IP sharers 400 and 450, the routers 700 and 750, the switching hubs 800 and 850, etc.

The communication methods between the IP terminal and the client according to the present invention can have the following advantages.

First, a task for installing an IP terminal in an IP network can be simplified because a communication method between the client and the IP terminal is improved

Second, a client in an IP network can communicate with an IP terminal even without the port mapping or port forwarding of an IP sharer.

Third, an ordinary person without specialized knowledge can install an IP terminal because the port mapping or port forwarding of an IP sharer is not performed.

Fourth, the time and costs necessary to install an IP terminal can be reduced because the port mapping or port forwarding of an IP sharer is not performed.

As described above, those skilled in the art to which the present invention pertains will appreciate that the present invention may be implemented in other detailed forms without departing from the technical spirit or essential characteristics of the present invention. Accordingly, the aforementioned embodiments should be constructed as being only illustrative from all aspects not as being restrictive. The scope of the present invention is defined by the following claims rather than the detailed description, and the meanings and scope of the claims and all changes or modified forms derived from their equivalents should be constructed as falling within the scope of the present invention.

1-11. (canceled)

12. A communication method between an IP terminal and a client in a system comprising a server configured to have a static certified IP address and port number, the IP terminal configured to have a private IP address and have its own unique information already registered with the server, the client that is another IP terminal having a private IP address and trying to communicate with the IP terminal through the server, IP terminal-side sharing devices configured to connect the IP terminal to an Internet over a network and to comprise at least one of an IP sharer and a router each having a private IP address on a LAN side and having a certified IP address on a WAN side, and client-side sharing devices configured to connect the client to the Internet over the network and to comprise at least one of an IP sharer and a router each having a private IP address on the LAN side and having a certified IP address on the WAN side, wherein communication between the server and the IP terminal, the client and the IP terminal-side sharing devices, and the client-side sharing devices is performed according to an IP method, the communication method comprising steps of:
the server regularly managing the unique information of the IP terminal and the WAN-side certified IP address and port number of the IP terminal-side sharing device corresponding to information related to the IP terminal, which are periodically transmitted by the IP terminal;
when communication request data comprising the unique information of the IP terminal is received from the client, the server sending the information related to the IP terminal to the WAN-side certified IP address and port number of the client-side sharing device so that the client receives the information related to the IP terminal; and
the client sending data to be transmitted to the IP terminal to the WAN-side certified IP address and port number of the IP terminal-side sharing device, and the IP terminal sending data to be transmitted to the client to the WAN-side certified IP address and port number of the client-side sharing device that have been obtained by analyzing the data received from the client so that the IP terminal and the client communicate with each other.

13. The communication method of claim 12, wherein the step of, when communication request data comprising the unique information of the IP terminal is received from the client, the server sending the information related to the IP terminal to the WAN-side certified IP address and port number of the client-side sharing device so that the client receives the information related to the IP terminal comprises:
sending the WAN-side certified IP address and port number of the client-side sharing device, corresponding to information related to the client, to the WAN-side certified IP address and port number of the IP terminal-side sharing device so that the IP terminal receives the information related to the client.

14. The communication method of claim 13, wherein one client communicates with a plurality of the IP terminals simultaneously or a plurality of the clients communicates with one terminal simultaneously.

15. A communication method between an IP terminal and a client in a system comprising a server configured to have a static certified IP address and port number, the IP terminal configured to have a private IP address and have its own unique information already registered with the server, the client that is another IP terminal having a private IP address and trying to communicate with the IP terminal through the server, and IP terminal-side sharing devices configured to connect the IP terminal to an Internet over a network and to comprise at least one of an IP sharer and a router each having a private IP address on a LAN side and having a certified IP address on a WAN side, wherein communication between the server and the IP terminal and between the client and the IP terminal-side sharing device is performed according to an IP method, the communication method comprising steps of:
the server regularly managing the unique information of the IP terminal and the WAN-side certified IP address and port number of the IP terminal-side sharing device corresponding to information related to the IP terminal, which are periodically transmitted by the IP terminal;
when communication request data comprising the unique information of the IP terminal is received from the client, the server sending the information related to the IP terminal to the certified IP address and port number of the client; and
the client sending data to be transmitted to the IP terminal to the WAN-side certified IP address and port number of the IP terminal-side sharing device, and the IP terminal sending data to be transmitted to the client to the certified IP address and port number of the client that have been obtained by analyzing the data received from the client so that the IP terminal and the client communicate with each other.

16. The communication method of claim 15, wherein the step of, when communication request data comprising the unique information of the IP terminal is received from the client, the server sending the information related to the IP terminal to the certified IP address and port number of the client comprises:
sending the certified IP address and port number of the client, corresponding to information related to the client, to the WAN-side certified IP address and port number of the IP terminal-side sharing device so that the IP terminal receives the information related to the client.

17. The communication method of claim 16, wherein one client communicates with a plurality of the IP terminals simultaneously or a plurality of the clients communicates with one terminal simultaneously.

18. A communication method between an IP terminal and a client in a system comprising a server configured to have a static certified IP address and port number, the IP terminal configured to have a private IP address and have its own unique information already registered with the server, the client that is another IP terminal having a private IP address and trying to communicate with the IP terminal through the server, IP terminal-side sharing devices configured to connect the IP terminal to an Internet over a network and to comprise at least one of an IP sharer and a router each having a private IP address on a LAN side and having a certified IP address on a WAN side, and client-side sharing devices configured to connect the client to the Internet over the network and to comprise at least one of an IP sharer and a router each having a private IP address on the LAN side and having a certified IP address on the WAN side, wherein communication between the server and the IP terminal, the client and the IP terminal-side sharing devices, and the client-side sharing devices is performed according to an IP method, the communication method comprising steps of:
the server regularly managing the unique information of the IP terminal and the WAN-side certified IP address and port number of the IP terminal-side sharing device corresponding to information related to the IP terminal, which are periodically transmitted by the IP terminal;
when communication request data comprising the unique information of the IP terminal is received from the client, the server sending the information related to the IP terminal to the WAN-side certified IP address and port number of the client-side sharing device so that the client receives the information related to the IP terminal; and
the client sending data to be transmitted to the IP terminal to the certified IP address and port number of the IP terminal and the IP terminal sending data to be transmitted to the client to the WAN-side certified IP address and port number of the client-side sharing device that have been obtained by analyzing the data received from the client, so the IP terminal and the client communicate with each other.

19. The communication method of claim 18, wherein the step of, when communication request data comprising the unique information of the IP terminal is received from the client, the server sending the information related to the IP terminal to the WAN-side certified IP address and port number of the client-side sharing device so that the client receives the information related to the IP terminal comprises:
sending the WAN-side certified IP address and port number of the client-side sharing device, corresponding to information related to the client, to the certified IP address and port number of the IP terminal.

20. The communication method of claim 19, wherein one client communicates with a plurality of the IP terminals simultaneously or a plurality of the clients communicates with one terminal simultaneously.

21. A communication method between an IP terminal and a client in a system comprising a server configured to have a static certified IP address and port number, the IP terminal configured to have a certified IP address and have its own unique information already registered with the server, and the client that is another IP terminal having a certified IP address and trying to communicate with the IP terminal through the server, wherein communication between the server, the IP terminal, and the client is performed according to an IP method, the communication method comprising steps of:
the server regularly managing the unique information of the IP terminal and the certified IP address and port number of the IP terminal corresponding to information related to the IP terminal, which are periodically transmitted by the IP terminal;
when communication request data comprising the unique information of the IP terminal is received from the client, the server sending the information related to the IP terminal to the certified IP address and port number of the client; and
the client sending data to be transmitted to the IP terminal to the certified IP address and port number of the IP terminal, and the IP terminal sending data to be transmitted to the client to the certified IP address and port number of the client that have been obtained by analyzing the data received from the client so that the IP terminal and the client communicate with each other.

22. The communication method of claim 21, wherein one client communicates with a plurality of the IP terminals simultaneously or a plurality of the clients communicates with one terminal simultaneously.

23. A communication method between an IP terminal and a client in a system comprising a server configured to have a static certified IP address and port number, the IP terminal configured to have a private IP address and have its own unique information already registered with the server, the client that is another IP terminal having a private IP address and trying to communicate with the IP terminal through the server, IP terminal-side sharing devices configured to connect the IP terminal to an Internet over a network and to comprise at least one of an IP sharer and a router each having a private IP address on a LAN side and having a certified IP address on a WAN side, and client-side sharing devices configured to connect the client to the Internet over the network and to comprise at least one of an IP sharer and a router each having a private IP address on the LAN side and having a certified IP address on the WAN side, wherein communication between the server and the IP terminal, the client and the IP terminal-side sharing devices, and the client-side sharing devices is performed according to an IP method, the communication method comprising steps of:
the server regularly managing the unique information of the IP terminal and the WAN-side certified IP address and port number of the IP terminal-side sharing device corresponding to information related to the IP terminal, which are periodically transmitted by the IP terminal;
when communication request data comprising the unique information of the IP terminal is received from the client, the server sending the WAN-side certified IP address and port number of the client-side sharing device, corresponding to information related to the client, to the WAN-side certified IP address and port number of the IP terminal-side sharing device so that the IP terminal receives the information related to the client; and
the IP terminal sending data to be transmitted to the client to the WAN-side certified IP address and port number of the client-side sharing device and the client sending data to be transmitted to the IP terminal to the WAN-side certified IP address and port number of the IP terminal-side sharing device that have been obtained by analyzing the data received from the IP terminal, so the IP terminal and the client communicate with each other.

24. The communication method of claim 23, wherein one client communicates with a plurality of the IP terminals simultaneously or a plurality of the clients communicates with one terminal simultaneously.

25. A communication method between an IP terminal and a client in a system comprising a server configured to have a static certified IP address and port number, the IP terminal configured to have a private IP address and have its own unique information already registered with the server, the client that is another IP terminal having a private IP address and trying to communicate with the IP terminal through the server, and IP terminal-side sharing devices configured to connect the IP terminal to an Internet over a network and to comprise at least one of an IP sharer and a router each having a private IP address on a LAN side and having a certified IP address on a WAN side, wherein communication between the server and the IP terminal and between the client and the IP terminal-side sharing device is performed according to an IP method, the communication method comprising steps of:
the server regularly managing the unique information of the IP terminal and the WAN-side certified IP address and port number of the IP terminal-side sharing device corresponding to information related to the IP terminal, which are periodically transmitted by the IP terminal;
when communication request data comprising the unique information of the IP terminal is received from the client, the server sending the certified IP address and port number of the client, corresponding to information related to the client, to the WAN-side certified IP address and port number of the IP terminal-side sharing device so that the IP terminal receives the information related to the client; and
the IP terminal sending data to be transmitted to the client to the certified IP address and port number of the client and the client sending data to be transmitted to the IP terminal to the WAN-side certified IP address and port number of the IP terminal-side sharing device that have been obtained by analyzing the data received from the IP terminal, so the IP terminal and the client communicate with each other.

26. The communication method of claim 25, wherein one client communicates with a plurality of the IP terminals simultaneously or a plurality of the clients communicates with one terminal simultaneously.

27. A communication method between an IP terminal and a client in a system comprising a server configured to have a static certified IP address and port number, the IP terminal configured to have a private IP address and have its own unique information already registered with the server, the client that is another IP terminal having a private IP address and trying to communicate with the IP terminal through the server, and client-side sharing devices configured to connect the client to the Internet over the network and to comprise at least one of an IP sharer and a router each having a private IP address on the LAN side and having a certified IP address on the WAN side, wherein communication between the server and the IP terminal and between the client and the client-side sharing devices is performed according to an IP method, the communication method comprising steps of:
the server regularly managing the unique information of the IP terminal and the certified IP address and port number of the IP terminal corresponding to information related to the IP terminal, which are periodically transmitted by the IP terminal;
when communication request data comprising the unique information of the IP terminal is received from the client, the server sending the WAN-side certified IP address and port number of the client-side sharing device, corresponding to information related to the client, to the certified IP address and port number of the IP terminal; and
the IP terminal sending data to be transmitted to the client to the WAN-side certified IP address and port number of the client-side sharing device and the client sending data to be transmitted to the IP terminal to the certified IP address and port number of the IP terminal that have been received by analyzing the data received from the IP terminal, so the IP terminal and the client communicate with each other.

28. The communication method of claim 27, wherein one client communicates with a plurality of the IP terminals simultaneously or a plurality of the clients communicates with one terminal simultaneously.
